(19) United States
(12) Patent Application Publication
(10) Pub. No.: US 2023/0346021 A1
(43) Pub. Date: Nov. 2, 2023

(54) AEROSOL-GENERATING DEVICE

(71) Applicant: KT&G CORPORATION, Daejeon (KR)

(72) Inventor: Taehun KIM, Yongin-si Gyeonggi-do (KR)

(73) Assignee: KT&G CORPORATION, Daejeon (KR)

(21) Appl. No.: 18/017,014

(22) PCT Filed: Mar. 3, 2022
(86) PCT No.: PCT/KR2022/002972

§ 371 Date: Jan. 19, 2023

(30) Foreign Application Priority Data
Mar. 16, 2021 (KR) 10-2021-0034023

(51) Int. Cl. A24F 40/42; A24F 40/46; A24F 40/50; A24F 40/60

(52) U.S. Cl. CPC A24F 40/42; A24F 40/46; A24F 40/50; A24F 40/60

(57) ABSTRACT

An aerosol-generating device is disclosed. The aerosol-generating device of the present disclosure includes a housing having therein an elongated insertion space; a cap configured to cover at least a portion of the housing at which the insertion space is formed, the cap comprising an opening corresponding to the insertion space; a cover coupled to the cap and movable to open or close the insertion space; a spring having a first side supported by the cap and a second side supported by the cover and configured to apply an elastic force to the cover; and a magnetic-force-generating unit mounted to the cap and operable to apply an attractive magnetic force or a repulsive magnetic force to the cover.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another object of the present disclosure to enable a user to conveniently open or close an insertion space, into which a stick is inserted.

It is still another object of the present disclosure to automatically close the insertion space if a user forgets to close the insertion space.

It is still another object of the present disclosure to prevent foreign substances from entering the insertion space, into which a stick is inserted.

### Solution to Problem

In accordance with an aspect of the present disclosure for accomplishing the above and other objects, there is provided an aerosol-generating device including a housing having therein an elongated insertion space; a cap configured to cover at least a portion of the housing at which the insertion space is formed, the cap comprising an opening corresponding to the insertion space; a cover coupled to the cap and movable to open or close the insertion space; a spring having a first side supported by the cap and a second side supported by the cover and configured to apply an elastic force to the cover; and a magnetic-force-generating unit mounted to the cap and operable to apply an attractive magnetic force or a repulsive magnetic force to the cover.

### Advantageous Effects of Invention

According to at least one of embodiments of the present disclosure, it is possible to enable a user to conveniently open or close an insertion space, into which a stick is inserted.

According to at least one of embodiments of the present disclosure, it is possible to automatically close the insertion space if a user forgets to close the insertion space.

According to at least one of embodiments of the present disclosure, it is possible to prevent foreign substances from entering the insertion space, into which a stick is inserted.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features, and other advantages of the present disclosure will be more clearly understood from the following detailed description taken in conjunction with the accompanying drawings, in which:

FIGS. 1 to 24 are views showing examples of an aerosol-generating device according to embodiments of the present disclosure.

### BEST MODE FOR CARRYING OUT THE INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Hereinafter, the directions of an aerosol-generating device 100 may be defined based on the coordinate system shown in the drawings.

In the coordinate system, the x-axis direction may be defined as the forward-backward direction of the aerosol-generating device 100. Here, based on the origin, the +x-axis direction may be the forward direction, and the −x-axis direction may be the backward direction.

In the coordinate system, the y-axis direction may be defined as the leftward-rightward direction of the aerosol-generating device 100. Here, based on the origin, the +y-axis direction may be the rightward direction, and the −y-axis direction may be the leftward direction.

In the coordinate system, the z-axis direction may be defined as the upward-downward direction of the aerosol-generating device 100. Here, based on the origin, the +z-axis direction may be the upward direction, and the −z-axis direction may be the downward direction.

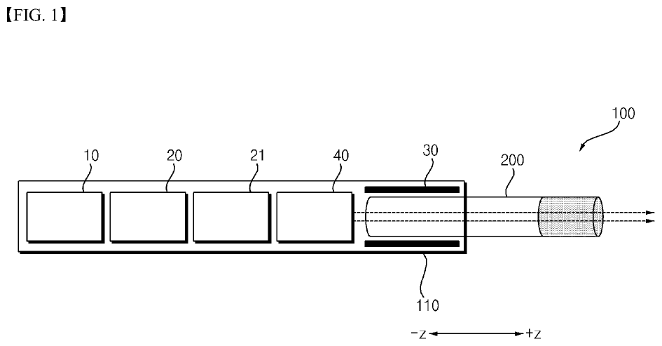

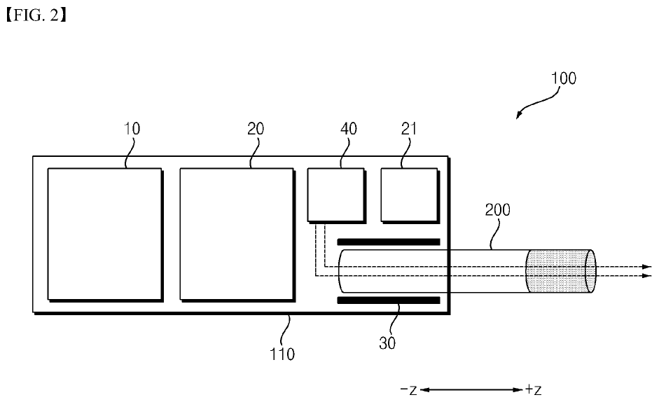

Referring to FIGS. 1 and 2, the aerosol-generating device 100 may include at least one of a battery 10, a controller 20, a heater 30, a cartridge 40, or a sensor 21. At least one of the battery 10, the controller 20, the heater 30, the cartridge 40, or the sensor 21 may be disposed inside a housing 110 of the aerosol-generating device 100.

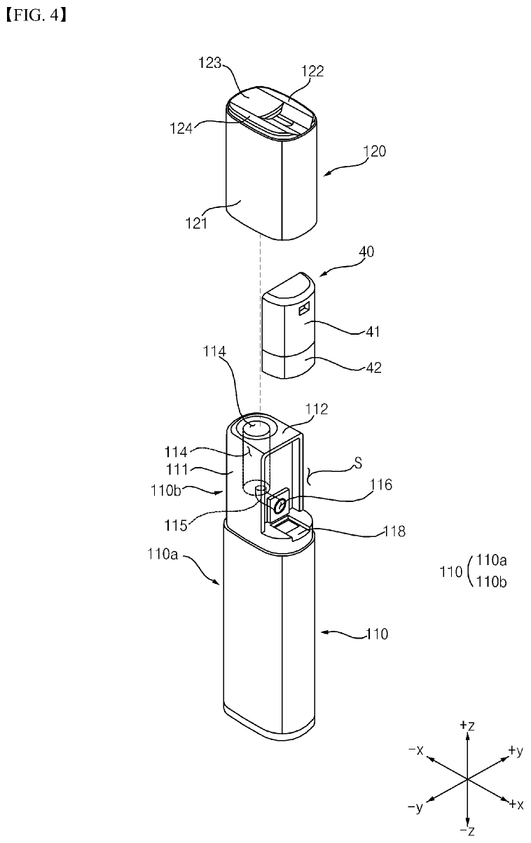

The housing 110 may be provided with an insertion space 114 (refer to FIG. 4), into which a stick 200 is inserted. The insertion space 114, into which the stick 200 is inserted, may be formed in the vicinity of the heater 30.

Referring to FIG. 1, the battery 10, the controller 20, the sensor 21, the cartridge 40, and the heater 30 may be arranged in a row. Referring to FIG. 2, the cartridge 40 and the heater 30 may be disposed parallel to each other so as to face each other. The internal structure of the aerosol-generating device 100 is not limited to that illustrated in the drawings.

The battery 10 may supply power so that at least one of the controller 20, the heater 30, the cartridge 40, or the sensor 21 operates. The battery 10 may supply power required to operate a display, a motor, etc. mounted in the aerosol-generating device 100. The battery 10 may be referred to as a power supply 10.

The controller 20 may control the overall operation of the aerosol-generating device 100. The controller 20 may control the operation of at least one of the battery 10, the heater 30, the cartridge 40, or the sensor 21. The controller 20 may control the operation of the display, the motor, etc. mounted in the aerosol-generating device 100. The controller 20 may determine whether the aerosol-generating device 100 is in an operable state by checking the state of each of the components of the aerosol-generating device 100.

The heater 30 may generate heat using power supplied from the battery 10. The heater 30 may heat the stick 200 inserted into the aerosol-generating device 100. The heater 30 may be referred to as a first heater 30.

The cartridge 40 may generate an aerosol. The aerosol generated by the cartridge may be delivered to a user through the stick 200 inserted into the aerosol-generating device 100. The cartridge 40 may be detachably coupled to the housing 110.

The sensor 21 may be disposed adjacent to the insertion space 114 (refer to FIG. 4). The sensor 21 may be disposed adjacent to the upper end of the insertion space 114. The sensor 21 may sense whether the stick 200 is disposed in the insertion space 114. The sensor 21 may sense whether the stick 200 is inserted into or removed from the insertion space 114, and may output the result of sensing to the controller 20.

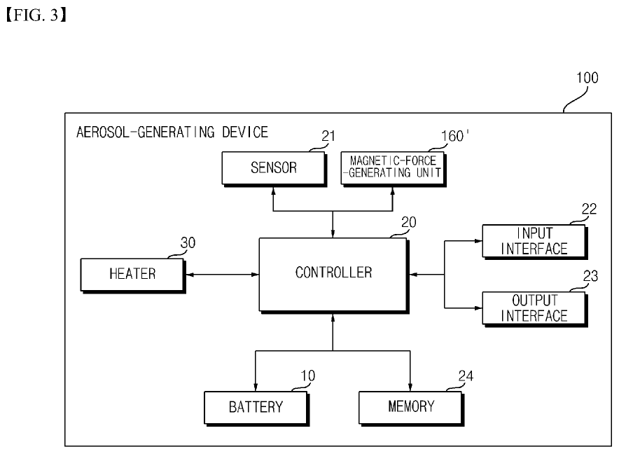

Referring to FIG. 3, the controller 20 may be electrically connected to various components. The controller 20 may control the components connected thereto.

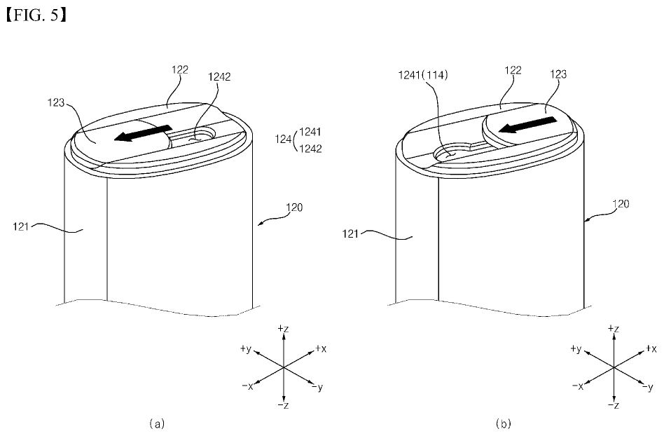

The controller 20 may be electrically connected to an input interface 22. The user may input various commands, such as turning on or turning off of the power supply, activation or deactivation of the heater, and opening or closing of a cover 123 (refer to FIG. 5), to the input interface 22. The controller 20 may receive a command from the input interface 22 to control the operation of the components.

The controller 20 may be electrically connected to an output interface 23. The output interface 23 may provide the user with various pieces of information, such as information about on/off operation of the power supply, information about whether the heater is operating, information about the stick, information about the liquid, information about the state of charge of the battery, and information about opening or closing of the cover. The controller 20 may control the output interface 23 to provide information to the user based on various pieces of information received from the components.

The output interface 23 may include a display. The display may display information to the outside to provide the same to the user.

The output interface 23 may include a haptic output interface. The haptic output interface may provide information to the user through vibration. The haptic output interface may include a vibration motor.

The output interface 23 may include a sound output interface. The sound output interface may output a sound corresponding to information to provide the information to the user. The sound output interface may include a speaker.

The controller 20 may be electrically connected to a memory 24. The memory 24 may store data on information. The memory 24 may receive data on various pieces of information from the controller 20 to store the same, or may transmit stored data to the controller 20. The controller 20 may control the operation of the components based on data received from the memory 24.

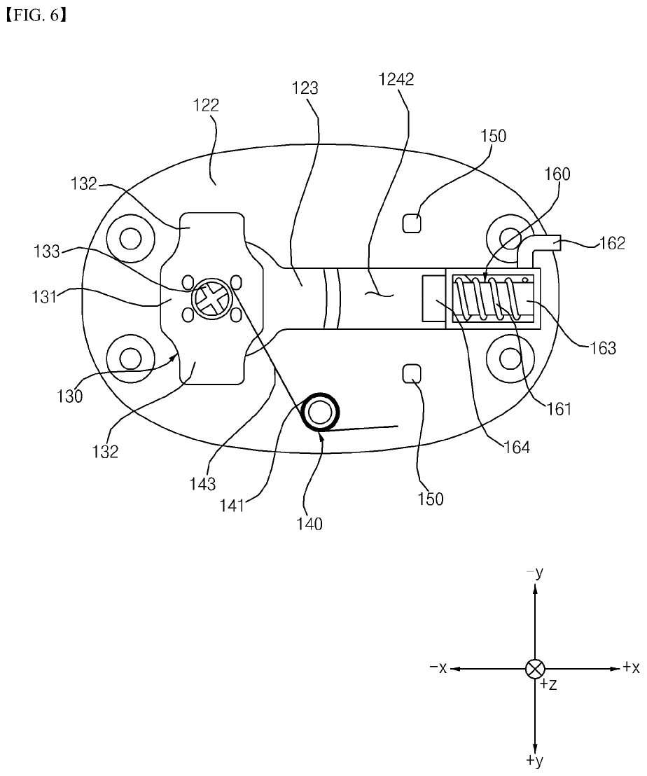

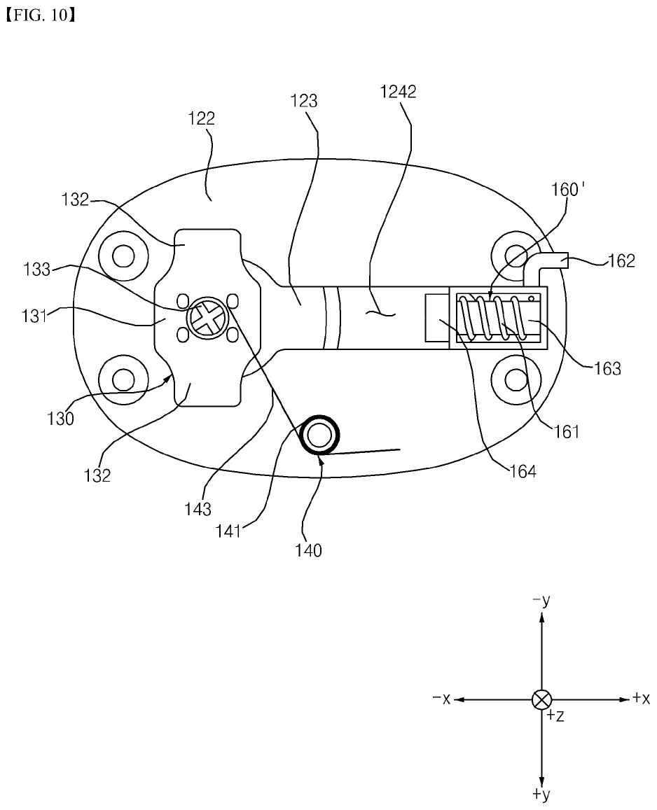

The controller 20 may be electrically connected to a magnetic-force-generating unit 160 or 160′ (refer to FIGS. 6 and 10). The controller 20 may control the power supply 10 to apply power to the magnetic-force-generating unit 160 or 160′.

Referring to FIG. 4, the housing 110 may include a lower housing 110a and an upper housing 110b. The upper housing 110b may be disposed on the lower housing 110a. The lower housing 110a may accommodate at least one of the battery 10, the controller 20, or the sensor 21 (refer to FIG. 2). The upper housing 110b may be coupled to the cartridge 40.

The housing 110 may provide an insertion space 114, which is elongated. The stick 200 may be inserted into the insertion space 114. The upper wall 112 of the upper housing 110b may be open, and the insertion space 114 may extend downwards from the open upper wall 112 of the upper housing 110b. The insertion space 114 may have a shape that is elongated in the upward-downward direction. The insertion space 114 may be surrounded by the sidewall 111 of the upper housing 110b.

The upper housing 110b may accommodate the first heater 30 (refer to FIGS. 1 and 2). The first heater 30 may be disposed around the insertion space 114.

The upper housing 110b may include a support surface 118, which extends in one direction from the lower portion of the sidewall 111 of the upper housing 110b. The upper housing 110b may include a mounting/demounting space S, which faces a portion of the sidewall 111 of the upper housing 110b and the support surface 118. The lower portion of the cartridge 40 may be in contact with and supported by the support surface 118 formed in the upper housing 110b. The cartridge 40 may be in contact with the support surface 118 to be electrically connected to other components located inside the aerosol-generating device 100.

An inlet 116 may be formed in the upper housing 110b. The inlet 116 may be connected to an outlet (not shown) formed in the cartridge 40. A connection passage 115 may be disposed between the inlet 116 and the insertion space 114. The connection passage 115 may connect the inlet 116 to the insertion space 114.

Accordingly, the aerosol generated in the cartridge 40 may be introduced into the inlet 116, and may flow toward the insertion space 114.

A cap 120 may cover at least a portion of the housing 110 in which the insertion space 114 is formed. The cap 120 may be detachably coupled to the outer side of the upper housing 110b. The cap 120 may cover the upper housing 110b and the cartridge 40 coupled to the upper housing 110b. The sidewall 121 of the cap 120 may cover the sidewall 111 of the upper housing 110b. The upper wall 122 of the cap 120 may cover the upper wall 112 of the upper housing 110b.

The cap 120 may have therein an opening 124, which is elongated at a position corresponding to the insertion space 114. The upper wall 122 of the cap 120 may be open to form the opening 124. When the cap 120 is coupled to the housing 110, the opening 124 may communicate with the insertion space 114. The opening 124 may have a shape that extends in one direction from a position corresponding to the insertion space 114.

The opening 124 may include a first part 1241 and a second part 1242. The first part 1241 may be formed at a position corresponding to the insertion space 114. The first part 1241 may have the same cross-section as the insertion space 114. The periphery of the cross-section of the first part 1241 may be the same as the periphery of the cross-section of the insertion space 114. When the cap 120 is coupled to the housing 110, the first part 1241 may be disposed above the insertion space 114. When the cap 120 is coupled to the housing 110, the first part 1241 may be connected to the insertion space 114.

The second part 1242 may be formed to extend in one direction from the first part 1241. The second part 1242 may have the shape of a slit. The width of the second part 1242 may be smaller than the width of the first part 1241. The second part 1242 may extend in the forward-backward direction.

The cover 123 may be mounted to the cap 120 so as to be movable along the opening 124. The cover 123 may open or close the insertion space 114. The cover 123 may close the insertion space 114 at a first position. The cover 123 may open the insertion space 114 at a second position.

Referring to FIG. 5, the cover 123 may move along the opening 124. The cover 123 may be exposed to the outside from the upper wall 122 of the cap 120.

The cover 123 may be located in the first part 1241 at the first position. When the cover 123 is located at the first position, the first part 1241 may be closed, and the second part 1242 may be opened. When the cover 123 is located at the first position, the cover 123 may be disposed above the insertion space 114. When the cover 123 is located at the first position, the cover 123 may close the insertion space 114.

The cover 123 may be located in the second part 1242 at the second position. The second position may be opposite the first position. When the cover 123 is located at the second position, the first part 1241 may be opened, and the second part 1242 may be closed. When the cover 123 is located at the second position, the cover 123 may be spaced apart from the insertion space 114 to thereby open the insertion space 114. When the cover 123 is located at the second position, the stick 200 may be inserted into the insertion space 114.

FIG. 6 is a view of the inner side of the upper wall 122 of the cap 120 when viewed upwards from beneath.

Referring to FIG. 6, a cover magnet 130 may be coupled to the cover 123. The cover magnet 130 may be coupled to the lower side of the cover 123. The cover magnet 130 may be formed integrally with the cover 123. Alternatively, the cover 123 may be made of a magnetic material. The cover 123 may include the cover magnet 130.

Hereinafter, the structure in which attractive magnetic force or repulsive magnetic force is applied to the cover magnet 130 will be described. However, attractive magnetic force or repulsive magnetic force may be applied to the cover 123. Application of attractive magnetic force or repulsive magnetic force to the cover 123 may mean direct application of attractive magnetic force or repulsive magnetic force to the cover 123 or application of attractive magnetic force or repulsive magnetic force to the cover magnet 130, which is included in or coupled to the cover 123.

The opening 124 may be located between the cover 123 and the cover magnet 130. The cover 123 may be disposed above the opening 124 (refer to FIG. 5), and the cover magnet 130 may be disposed below the opening 124. The cover magnet 130 may move together with the cover 123.

When the cover 123 is located at the first position, the cover magnet 130 may be located at the first position. When the cover 123 is located at the second position, the cover magnet 130 may be located at the second position.

The cover magnet 130 may include a magnet body 131 and a magnet wing 132 extending from the magnet body 131. The magnet body 131 may be disposed adjacent to the center of the cover 123. The magnet wing 132 may extend from the magnet body 131 to the outside of the opening 124. The magnet wing 132 may be provided in a pair, and the pair of magnet wings 132 may extend in the leftward direction and the rightward direction. The upper wall 122 of the cap 120, which surrounds the opening 124, may be disposed between the magnet wings 132 and the cover 123.

A protruding portion 133 may protrude downwards from the cover 123 and the cover magnet 130. The protruding portion 133 may fix the cover 123 and the cover magnet 130. For example, the protruding portion 133 may include a screw. The protruding portion 133 may be in contact with a spring 140.

One side of the spring 140 may be supported by the cap 120, and the other side of the spring 140 may be supported by the cover 123. Thereby, the spring 140 may apply elastic force to the cover 123. The spring 140 may press the cover 123 toward the first position.

The spring 140 may be a torsion spring. The spring 140 may include a spring body 141, which is wound multiple times to form a body, and a spring bar 143, which extends in one direction from the spring body 141. The spring body 141 may be fixed to the upper wall 122 of the cap 120. The spring bar 143 may be in contact with the protruding portion 133. The spring bar 143 may pivot from the spring body 141 to apply elastic force to the cover 123 toward the first position.

A first magnet 150 may be disposed adjacent to the second position. The first magnet 150 may apply attractive magnetic force to the cover magnet 130. When the cover 123 is located at the second position, the first magnet 150 may be in direct or indirect contact with the cover magnet 130. The cover magnet 130 may be detachably attached to the first magnet 150.

When the cover 123 is located at the second position, the first magnet 150 may be in direct or indirect contact with the magnet body 131 and/or the magnet wings 132. The first magnet 150 may be provided in a pair, and the pair of first magnets 150 may be disposed to the left side and the right side, with the second part 1242 interposed therebetween. The pair of first magnets 150 may respectively come into contact with the pair of magnet wings 132. The cover magnet 130 and the first magnets 150 may be permanent magnets.

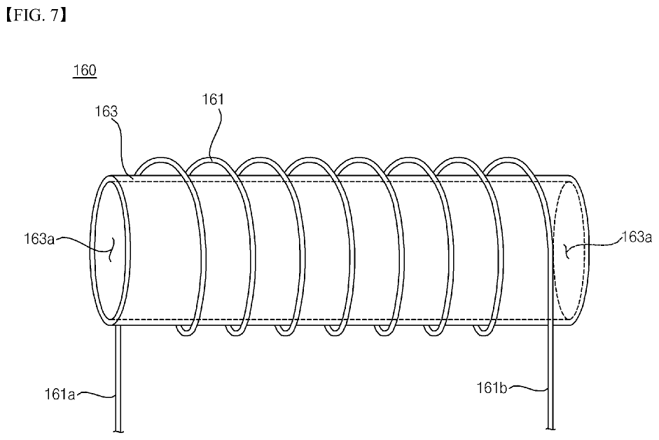

Referring to FIGS. 6 and 7, the magnetic-force-generating unit 160 may be mounted to the cap 120 so as to be adjacent to the cover 123. The magnetic-force-generating unit 160 may be mounted to the upper wall 122 of the cap 120. The magnetic-force-generating unit 160 may apply attractive magnetic force or repulsive magnetic force to the cover 123.

The magnetic-force-generating unit 160 may be disposed adjacent to the second position. The magnetic-force-generating unit 160 may be disposed adjacent to an end portion of the second part 1242.

When power is applied to the magnetic-force-generating unit 160, the magnetic-force-generating unit 160 may be magnetized. The direction of the electrodes formed in the magnetic-force-generating unit 160 may vary depending on the direction in which current flows. The magnetic-force-generating unit 160 may receive power from the power supply 10 to apply repulsive magnetic force to the cover 123 and/or the cover magnet 130. The magnetic-force-generating unit 160 may apply repulsive magnetic force to the cover 123 and/or the cover magnet 130 from the second position toward the first position.

The magnetic-force-generating unit 160 may include a solenoid 161. The solenoid 161 may be connected to the power supply 10 via a connection part 162. The solenoid 161 may be wound in the direction in which the opening 124 extends. The solenoid 161 may be wound in the forward-backward direction so as to be elongated in the forward-backward direction. The solenoid 161 may be a magnetic material.

When the solenoid 161 receives power, the solenoid 161 may be magnetized to have poles. When current is supplied to one side 161a of the solenoid 161, the vicinity of one side 161a of the solenoid 161 may be magnetized to an S-pole, and the vicinity of the other side 161b of the solenoid 161 may be magnetized to an N-pole. When current is supplied to the other side 161b of the solenoid 161, the vicinity of one side 161a of the solenoid 161 may be magnetized to an N-pole, and the vicinity of the other side 161b of the solenoid 161 may be magnetized to an S-pole.

An electromagnet 163 may be disposed inside the solenoid 161. The electromagnet 163 may extend in the direction in which the solenoid 161 is wound. The electromagnet 163 may have the shape of a cylinder that has formed therein an empty space 163a. A portion of the electromagnet 163 may extend from the solenoid 161 toward the opening 124 to form a contact portion 164. The contact portion 164 may have a shape that gradually widens from the solenoid 161 toward the opening 124. The electromagnet 163 may be a magnetic material. The electromagnet 163 may be a ferromagnetic material. The electromagnet 163 may be fixed inside the solenoid 161 so as not to move.

The electromagnet 163 may be magnetized only when current flows through the solenoid 161. When the solenoid 161 receives power, the electromagnet 163 may be magnetized to have poles. When current is supplied to one side 161a of the solenoid 161, one side of the electromagnet 163 may be magnetized to an S-pole, and the other side of the electromagnet 163 may be magnetized to an N-pole. When current is supplied to the other side 161b of the solenoid 161, one side of the electromagnet 163 may be magnetized to an N-pole, and the other side of the electromagnet 163 may be magnetized to an S-pole. The solenoid 161 may form a magnetic field alone, but may form a stronger magnetic field using the electromagnet 163.

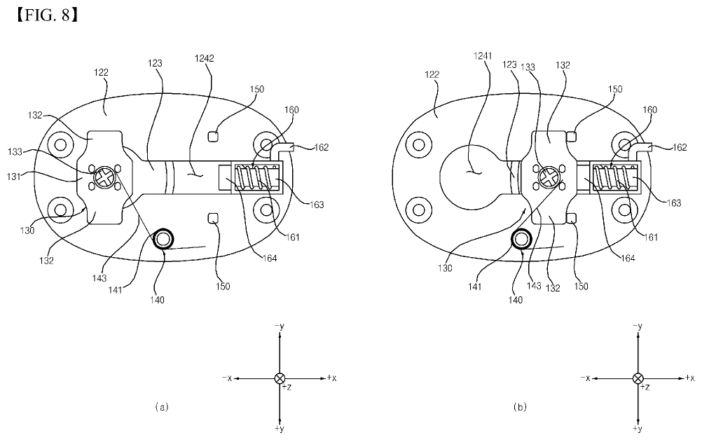

Referring to FIG. 8, the cover 123 may move from the first position to the second position. The user may open the insertion space 114 (refer to FIG. 4) by moving the cover 123 from the first position to the second position.

When the cover 123 is located at the second position, the cover 123 and/or the cover magnet 130 may be in direct or indirect contact with the first magnets 150. When the cover 123 is located at the second position, the cover 123 and/or the cover magnet 130 may be in contact with the magnetic-force-generating unit 160. When the cover 123 is located at the second position, the magnet body 131 and the contact portion 164 may be in contact with each other. The first magnets 150 may apply attractive magnetic force to the cover magnet 130.

The attractive magnetic force between the first magnets 150 and the cover magnet 130 may be stronger than the force by which the spring 140 presses the cover 123 toward the first position.

Accordingly, when the cover 123 is located at the second position, the cover 123 may not be moved to the first position by the spring 140, but may be fixed at the second position.

Accordingly, after the user moves the cover 123 to the second position in order to open the insertion space 114, the cover 123 may remain at the second position in the state in which the insertion space 114 is opened.

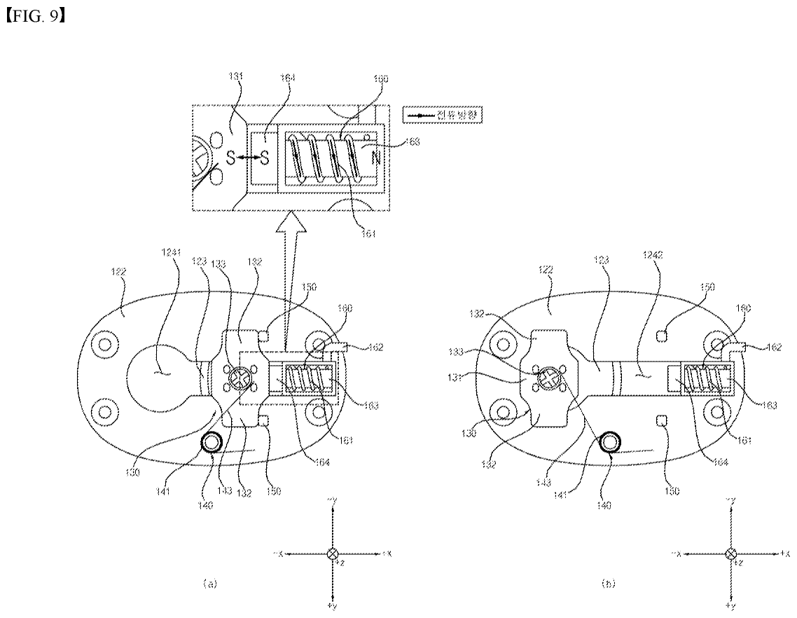

Referring to FIG. 9, the magnetic-force-generating unit 160 may be magnetized when power is applied thereto. When the magnetic-force-generating unit 160 receives power and current flows therethrough in one direction, the magnetic-force-generating unit 160 may apply repulsive magnetic force to the cover 123 and/or the cover magnet 130.

The repulsive magnetic force between the magnetic-force-generating unit 160 and the cover magnet 130 may be stronger than the attractive magnetic force between the cover magnet 130 and the first magnets 150. The repulsive magnetic force between the magnetic-force-generating unit 160 and the cover magnet 130 may be greater than the magnitude obtained by subtracting the force by which the spring 140 presses the cover 130 toward the first position from the attractive magnetic force between the cover magnet 130 and the first magnets 150.

When power is applied to the magnetic-force-generating unit 160 to apply repulsive magnetic force to the cover magnet 130, the cover magnet 130 may be separated from the magnetic-force-generating unit 160. When power is applied to the magnetic-force-generating unit 160 to apply repulsive magnetic force to the cover magnet 130, the cover magnet 130 may be separated from the first magnets 150. When the cover 123 and/or the cover magnet 130 is separated from the first magnets 150, the cover 123 may be moved to the first position by the elastic force applied thereto by the spring 140.

Power may be briefly applied to the magnetic-force-generating unit 160 for a predetermined time period. When the cover 123 and/or the cover magnet 130 is separated from the first magnets 150, or when the cover 123 and/or the cover magnet 130 is located at the first position, power may not be applied to the magnetic-force-generating unit 160.

Accordingly, it is possible to automatically move the cover 123 from the second position to the first position by applying power to the magnetic-force-generating unit 160.

Accordingly, the user may be capable of conveniently closing the insertion space 114.

Referring to FIGS. 10 to 12, a magnetic-force-generating unit 160′ may include a second magnet 165, which is disposed inside the solenoid 161. When the cover 123 is located at the second position, the cover magnet 130 may be in direct or indirect contact with the magnetic-force-generating unit 160′. The second magnet 165 may apply attractive magnetic force to the cover magnet 130. The second magnet 165 may be a permanent magnet.

The electromagnet 163 may have formed therein an empty space 163a (refer to FIG. 7). The second magnet 165 may be disposed in the empty space 163a in the electromagnet 163. The second magnet 165 may be fixed inside the solenoid 161 so as not to move. The second magnet 165 may extend in the direction in which the solenoid 161 is wound.

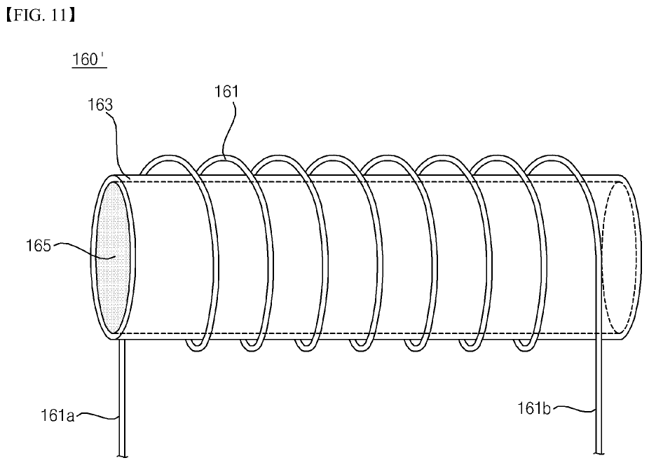

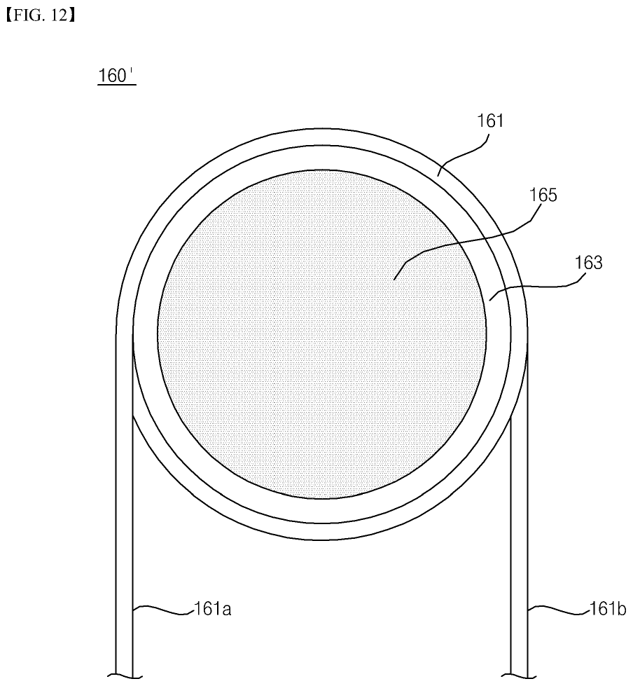

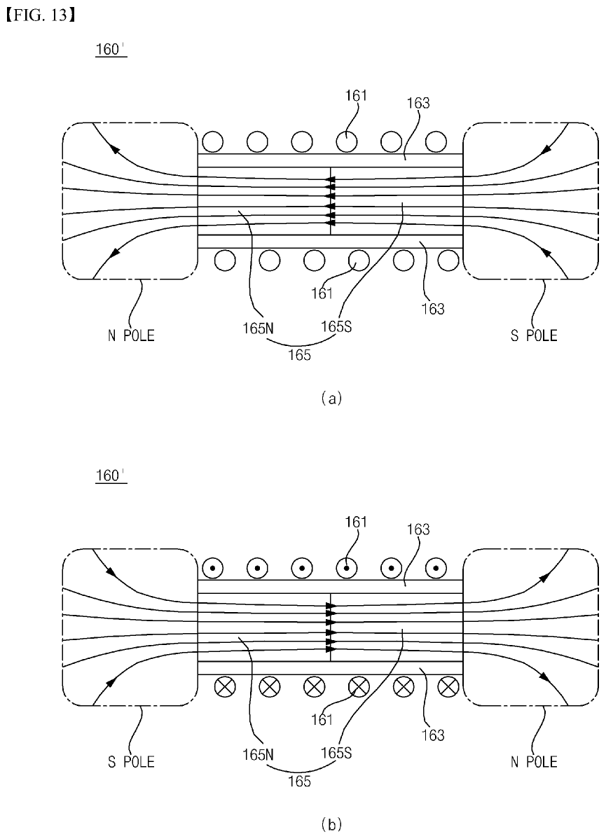

FIG. 13 is a cross-sectional view of the magnetic-force-generating unit 160′ shown in FIGS. 11 and 12. Specifically, FIG. 13(a) shows lines of magnetic force when current does not flow through the solenoid 161, and FIG. 13(b) shows lines of magnetic force when current flows through the solenoid 161 in one direction.

Referring to FIG. 13, the second magnet 165 may be disposed inside the solenoid 161, and may have an N-pole 165N on one side and an S-pole 165S on the other side.

When current does not flow through the solenoid 161, one side of the magnetic-force-generating unit 160′ may have an N-pole, and the other side of the magnetic-force-generating unit 160′ may have an S-pole due to the magnetic force generated by the second magnet 165.

When current flows through the solenoid 161, the magnetic force generated by the solenoid 161 and the magnetic force generated by the second magnet 165 may act in opposite directions. When current flows through the solenoid 161, the magnetic flux generated by the second magnet 165 may be canceled by the magnetic flux generated by the solenoid 161 and the electromagnet 163. The magnetic flux generated by the solenoid 161 may be greater than the magnetic flux generated by the second magnet 165. When current flows through the solenoid 161, one side of the magnetic-force-generating unit 160′ may have an S-pole, and the other side of the magnetic-force-generating unit 160′ may have an N-pole.

Accordingly, the polarity of the magnetic-force-generating unit 160′ when current does not flow through the solenoid 161 and the polarity thereof when current flows through the solenoid 161 may be opposite each other.

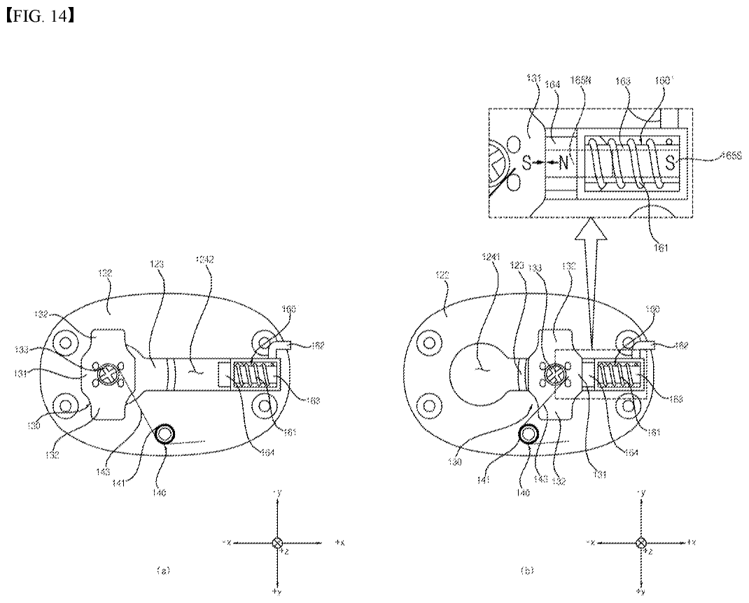

Referring to FIG. 14, the cover 123 may move from the first position to the second position. The user may open the insertion space 114 (refer to FIG. 4) by moving the cover 123 from the first position to the second position.

When the cover 123 is located at the second position, the cover magnet 130 may be in direct or indirect contact with the magnetic-force-generating unit 160′. When the cover 123 is located at the second position, the magnet body 131 may be in direct or indirect contact with the contact portion 164. The contact portion 164 may surround the second magnet 165.

When power is not applied to the magnetic-force-generating unit 160′, the magnetic-force-generating unit 160′ may apply attractive magnetic force to the cover magnet 130. The second magnet 165 (refer to FIGS. 11 to 13) may apply attractive magnetic force to the cover magnet 130.

The attractive magnetic force between the second magnet 165 and the cover magnet 130 may be stronger than the force by which the spring 140 presses the cover 123 toward the first position.

Accordingly, when the cover 123 is located at the second position, the cover 123 may not be moved to the first position by the spring 140, but may be fixed at the second position.

Accordingly, after the user moves the cover 123 to the second position in order to open the insertion space 114, the cover 123 may remain at the second position in the state in which the insertion space 114 is opened.

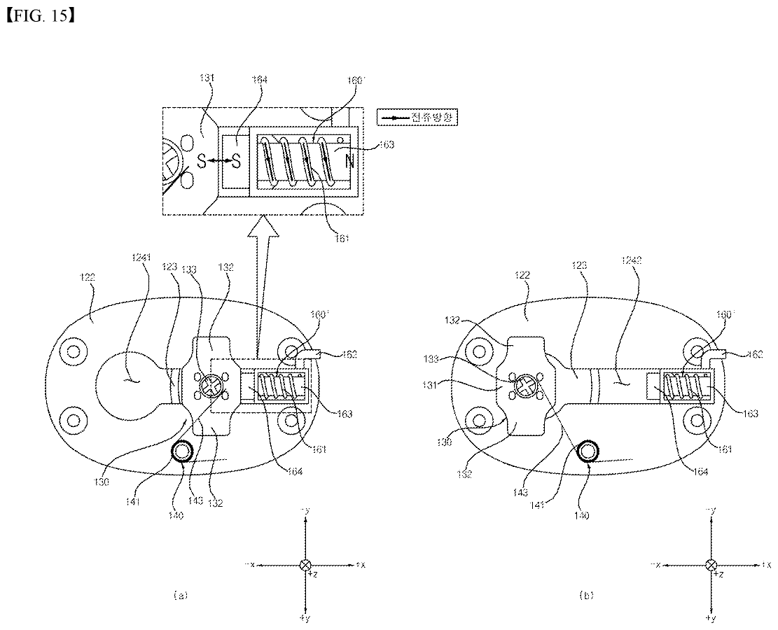

Referring to FIG. 15, the magnetic-force-generating unit 160′ may be magnetized when power is applied thereto. When the magnetic-force-generating unit 160′ receives power and current flows therethrough in one direction, the magnetic-force-generating unit 160′ may apply repulsive magnetic force to the cover magnet 130.

When power is applied to the magnetic-force-generating unit 160′ to apply repulsive magnetic force to the cover magnet 130, the cover magnet 130 may be separated from the magnetic-force-generating unit 160′. When power is applied to the magnetic-force-generating unit 160′ to apply repulsive magnetic force to the cover magnet 130, the cover magnet 130 may be separated from the magnetic-force-generating unit 160′. When the cover magnet 130 is separated from the magnetic-force-generating unit 160′, the cover 123 may be moved from the second position to the first position by the elastic force applied thereto by the spring 140.

Power may be briefly applied to the magnetic-force-generating unit 160′ for a predetermined time period. When the cover magnet 130 is separated from the magnetic-force-generating unit 160′, or when the cover magnet 130 is located at the first position, power may not be applied to the magnetic-force-generating unit 160′.

Accordingly, it is possible to automatically move the cover 123 from the second position to the first position by applying power to the magnetic-force-generating unit 160′.

Accordingly, the user may be capable of conveniently closing the insertion space 114.

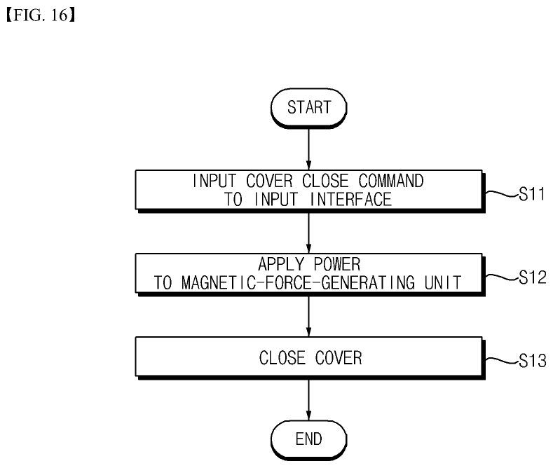

Referring to FIG. 16, in the state in which the cover 123 is opened and located at the second position, the user may input a cover close command to the input interface 22 (S11). When the cover close command is input to the input interface 22 (S11), the controller 20 may apply power to the magnetic-force-generating unit 160 or 160′ (S12).

Accordingly, the magnetic-force-generating unit 160 or 160′ may apply repulsive magnetic force to the cover magnet 130 to push the cover 123 from the second position toward the first position.

Accordingly, the cover 123 may be automatically closed in response to the user command, thereby closing the insertion space 114 (S13).

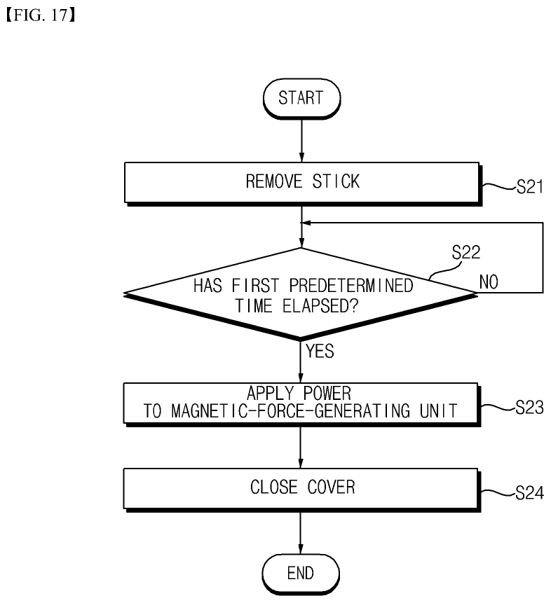

Referring to FIG. 17, in the state in which the cover 123 is opened and located at the second position, the stick 200 may be inserted into the insertion space 114. The sensor 21 may sense whether the stick 200 is disposed in the insertion space 114. The sensor 21 may sense whether the stick 200 is separated from the insertion space 114 (S21).

When the stick 200 is separated from the insertion space 114 (S21), the controller may apply power to the magnetic-force-generating unit 160 or 160′ (S23).

Accordingly, the magnetic-force-generating unit 160 or 160′ may apply repulsive magnetic force to the cover magnet 130 to push the cover 123 from the second position toward the first position.

Accordingly, when the stick 200 is separated from the insertion space 114, the cover 123 may automatically close the insertion space 114 (S24).

After the stick 200 is separated from the insertion space 114 (S21), when a first predetermined time has elapsed (Yes in S22), the controller 20 may apply power to the magnetic-force-generating unit 160 or 160′ (S23). After the stick 200 is separated from the insertion space 114 (S21), before the first predetermined time elapses (No in S22), the controller 20 may not apply power to the magnetic-force-generating unit 160 or 160′. The first predetermined time may be set in consideration of the time that is generally taken to completely pull the stick 200 out of the insertion space 114. The sensor 21 may be disposed adjacent to the upper end of the insertion space 114.

Accordingly, the cover 123 may close the insertion space 114 when the stick 200 is completely removed from the insertion space 114.

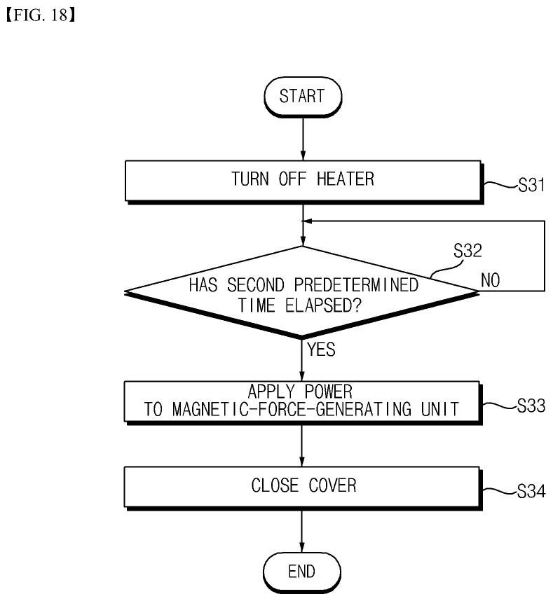

Referring to FIG. 18, the heater 30 may be switched from an on state to an off state (S31). When the heater 30 is turned off (S31), the controller 20 may apply power to the magnetic-force-generating unit 160 or 160′ (S33).

Accordingly, the magnetic-force-generating unit 160 or 160′ may apply repulsive magnetic force to the cover magnet 130 to push the cover 123 from the second position toward the first position.

Accordingly, when the heater 30 is turned off, the cover 123 may be automatically closed to thereby close the insertion space 114 (S34).

After the heater 30 is turned off (S31), when a second predetermined time has elapsed (Yes in S32), the controller 20 may apply power to the magnetic-force-generating unit 160 or 160′ (S33). After the heater 30 is turned off (S31), before the second predetermined time elapses (No in S32), the controller 20 may not apply power to the magnetic-force-generating unit 160 or 160′. The second predetermined time may be set in consideration of the time that is generally taken to pull the stick 200 out of the insertion space 114 after the heater 30 is turned off.

Accordingly, when a predetermined period of time, long enough for the user to remove the stick 123, elapses after the heater 30 is turned off, the cover 123 may be closed to thereby close the insertion space 114.

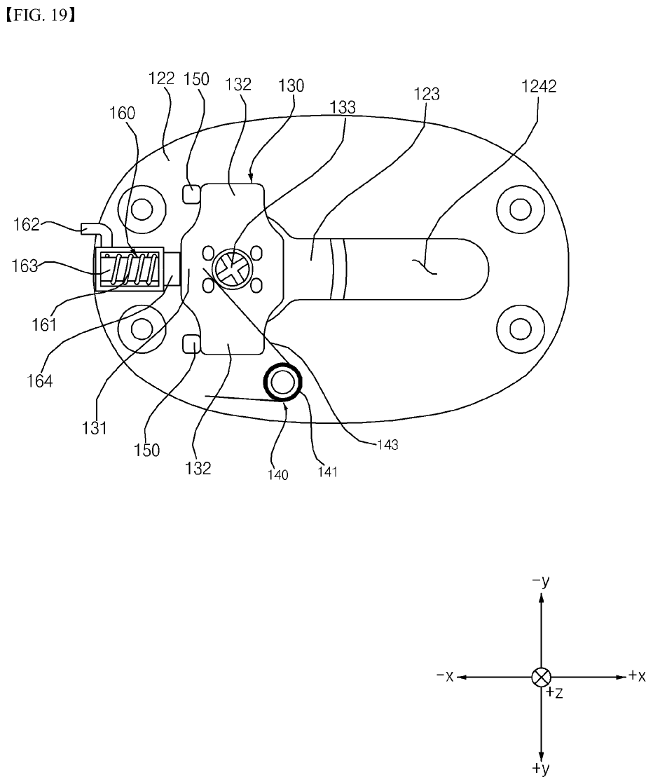

Referring to FIG. 19, the spring 140 may press the cover 123 to the second position. The spring bar 143 may pivot from the spring body 141 to apply elastic force to the cover 123 toward the second position.

The first magnet 150 may be disposed adjacent to the first position. The first magnet 150 may apply attractive magnetic force to the cover magnet 130. When the cover 123 is located at the first position, the first magnet 150 may be in direct or indirect contact with the cover magnet 130. The cover magnet 130 may be detachably attached to the first magnet 150.

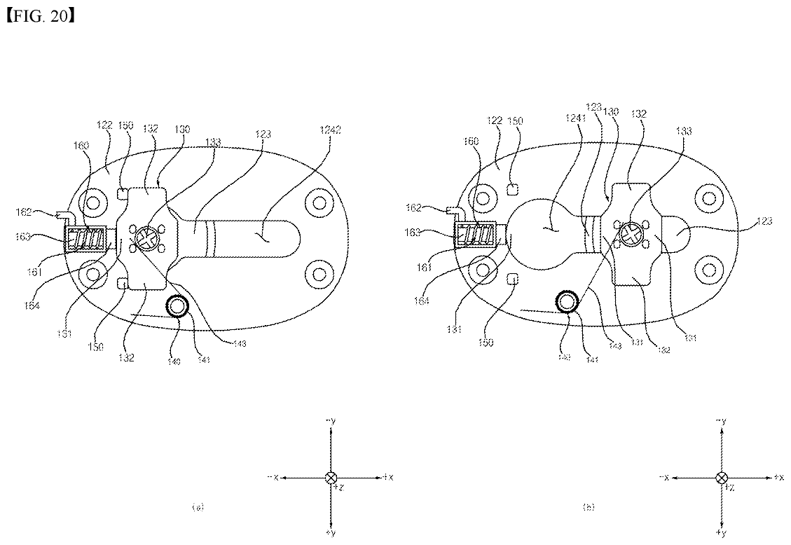

When the cover 123 is located at the first position, the first magnet 150 may be in direct or indirect contact with the magnet body 131 and/or the magnet wings 132. The first magnet 150 may be provided in a pair, and the pair of first magnets 150 may be disposed to the left side and the right side, with the first part 1241 (refer to FIG. 20) interposed therebetween.

The magnetic-force-generating unit 160 may be disposed adjacent to the first position. The magnetic-force-generating unit 160 may be disposed adjacent to an end portion of the first part 1241 (refer to FIG. 20).

When power is applied to the magnetic-force-generating unit 160, the magnetic-force-generating unit 160 may be magnetized. The magnetic-force-generating unit 160 may receive power from the power supply 10 to apply repulsive magnetic force to the cover magnet 130. The magnetic-force-generating unit 160 may apply repulsive magnetic force to the cover magnet 130 from the first position toward the second position.

Referring to FIG. 20, the first magnets 150 may apply attractive magnetic force to the cover magnet 130. The attractive magnetic force between the first magnets 150 and the cover magnet 130 may be stronger than the force by which the spring 140 presses the cover 123 toward the second position.

Accordingly, when the cover 123 is located at the first position, the cover 123 may not be moved to the second position by the spring 140, but may be fixed at the first position.

Accordingly, if the user does not open the cover 123, the cover 123 may be maintained in the state in which the insertion space 114 is closed.

When the magnetic-force-generating unit 160 receives power and current flows therethrough in one direction, the magnetic-force-generating unit 160 may apply repulsive magnetic force to the cover magnet 130.

The repulsive magnetic force between the magnetic-force-generating unit 160 and the cover magnet 130 may be stronger than the attractive magnetic force between the cover magnet 130 and the first magnets 150. The repulsive magnetic force between the magnetic-force-generating unit 160 and the cover magnet 130 may be greater than the magnitude obtained by subtracting the force by which the spring 140 presses the cover 130 toward the second position from the attractive magnetic force between the cover magnet 130 and the first magnets 150.

When power is applied to the magnetic-force-generating unit 160 to apply repulsive magnetic force to the cover magnet 130, the cover magnet 130 may be separated from the magnetic-force-generating unit 160. When power is applied to the magnetic-force-generating unit 160 to apply repulsive magnetic force to the cover magnet 130, the cover magnet 130 may be separated from the first magnets 150. When the cover magnet 130 is separated from the first magnets 150, the cover 123 may be moved to the second position by the elastic force applied thereto by the spring 140.

Power may be briefly applied to the magnetic-force-generating unit 160 for a predetermined time period. When the cover magnet 130 is separated from the first magnets 150, or when the cover magnet 130 is located at the second position, power may not be applied to the magnetic-force-generating unit 160.

Accordingly, it is possible to automatically move the cover 123 from the first position to the second position by applying power to the magnetic-force-generating unit 160.

Accordingly, the user may be capable of conveniently opening the insertion space 114.

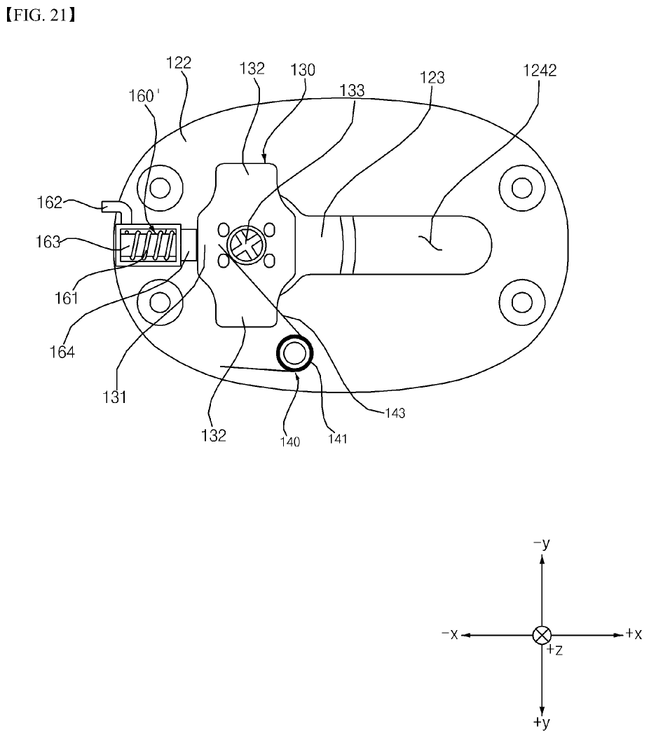

Referring to FIG. 21, the magnetic-force-generating unit 160′, which includes the second magnet 165 (refer to FIGS. 11 to 13), may be disposed adjacent to the first position. When the cover 123 is located at the first position, the cover magnet 130 may be in direct or indirect contact with the magnetic-force-generating unit 160′.

When power is not applied to the magnetic-force-generating unit 160′, the magnetic-force-generating unit 160′ may apply attractive magnetic force to the cover magnet 130. The second magnet 165 may apply attractive magnetic force to the cover magnet 130. When power is applied to the magnetic-force-generating unit 160′, the magnetic-force-generating unit 160′ may apply repulsive magnetic force to the cover magnet 130.

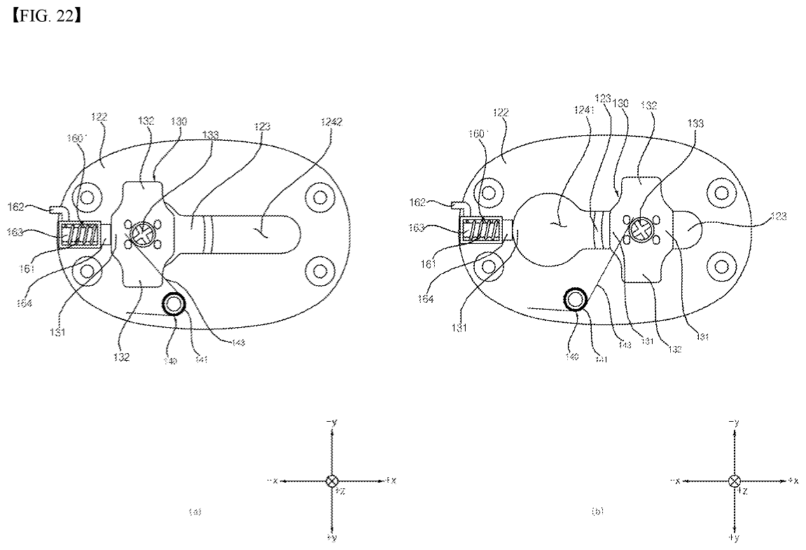

Referring to FIG. 22, when power is not applied to the magnetic-force-generating unit 160′, the attractive magnetic force applied to the cover magnet 130 by the magnetic-force-generating unit 160′ may be stronger than the force by which the spring 140 presses the cover 123 toward the second position. The attractive magnetic force between the second magnet 165 and the cover magnet 130 may be stronger than the force by which the spring 140 presses the cover 123 toward the second position.

When power is applied to the magnetic-force-generating unit 160′ to apply repulsive magnetic force to the cover magnet 130, the cover magnet 130 may be separated from the magnetic-force-generating unit 160′. When the cover magnet 130 is separated from the magnetic-force-generating unit 160′, the cover 123 may be moved from the first position to the second position by the elastic force applied thereto by the spring 140.

Accordingly, when the cover 123 is located at the first position, the cover 123 may not be moved to the second position by the spring 140, but may be fixed at the first position.

Accordingly, if the user does not open the cover 123, the cover 123 may be maintained in the state in which the insertion space 114 is closed.

Accordingly, it is possible to automatically move the cover 123 from the first position to the second position by applying power to the magnetic-force-generating unit 160′.

Accordingly, the user may be capable of conveniently opening the insertion space 114.

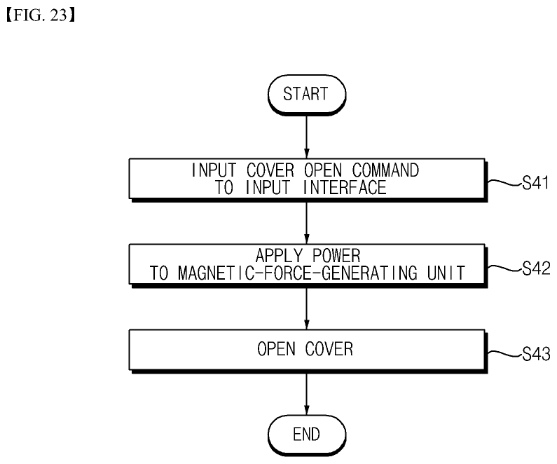

Referring to FIG. 23, in the state in which the cover 123 is closed and located at the first position, the user may input a cover open command to the input interface 22 (S41). When the cover open command is input to the input interface 22 (S41), the controller 20 may apply power to the magnetic-force-generating unit 160 or 160′ (S42).

Accordingly, the magnetic-force-generating unit 160 or 160′ may apply repulsive magnetic force to the cover magnet 130 to push the cover 123 from the first position toward the second position.

Accordingly, the cover 123 may be automatically opened in response to the user command, thereby opening the insertion space 114 (S43).

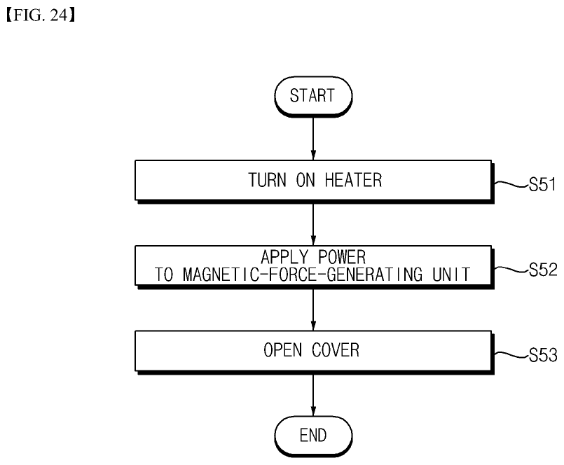

Referring to FIG. 24, the heater 30 may be switched from an off state to an on state (S51). When the heater 30 is turned on (S51), the controller 20 may apply power to the magnetic-force-generating unit 160 or 160′ (S52).

Accordingly, the magnetic-force-generating unit 160 or 160′ may apply repulsive magnetic force to the cover magnet 130 to push the cover 123 from the first position toward the second position.

Accordingly, when the heater 30 is turned on, the cover 123 may be automatically opened, thereby opening the insertion space 114 (S53).

Referring to FIGS. 1 to 24, an aerosol-generating device 100 in accordance with one aspect of the present disclosure may include a housing 110 having therein an elongated insertion space 114, a cap 120, which covers at least a portion of the housing 110 at which the insertion space 114 is formed, the cap comprising an opening 124 corresponding to the insertion space 114, a cover 123 coupled to the cap 120 and movable to open or close the insertion space, a spring 140 having a first side supported by the cap 120 and a second side supported by the cover 123 and configured to apply an elastic force to the cover 123, and a magnetic-force-generating unit 160 or 160′ mounted to the cap 120 and operable to apply an attractive magnetic force or a repulsive magnetic force to the cover 123.

In addition, in accordance with another aspect of the present disclosure, the cover 123 may be moveable between a first position at which the insertion space 114 is closed and a second position at which the insertion space 114 is open. The magnetic-force-generating unit 160 or 160′ may be disposed adjacent to the second position and may be operable to apply the repulsive magnetic force to the cover 123 toward the first position when power is applied thereto.

In addition, in accordance with another aspect of the present disclosure, the aerosol-generating device may further comprise a first magnet disposed adjacent to the second position to apply a second attractive magnetic force to the cover to secure the cover at the second position. the spring 140 may be configured to apply the elastic force to the cover 123 toward the first position.

In addition, in accordance with another aspect of the present disclosure, the cover 123 may be secured at the second position by the second attractive magnetic force applied by the first magnet 150 to the cover 123 despite the elastic force applied to the cover 123 by the spring 140 toward the first position.

In addition, in accordance with another aspect of the present disclosure, the repulsive magnetic force by the magnetic-force-generating unit 160 may overcome the second attractive magnetic force of the first magnet 150 securing the cover at the second position to move the cover toward the first position.

In addition, in accordance with another aspect of the present disclosure, the spring 140 may be configured to apply the elastic force to the cover 123 toward the first position. The magnetic-force-generating unit 160′ may include a solenoid 161, and a second magnet 165, disposed inside the solenoid 161 to apply a third attractive magnetic force to the cover 123.

In addition, in accordance with another aspect of the present disclosure, the third attractive magnetic force may secure the cover 123 at the second position when power is not applied to the magnetic-force-generating unit 160′ to overcome the third attractive magnetic force and move the cover 123 toward the first position when power is applied to the magnetic-force-generating unit 160′.

In addition, in accordance with another aspect of the present disclosure, the cover 123 may be secured at the second position by the third attractive magnetic force applied by the second magnet 165 to the cover 123 despite the elastic force applied to the cover 123 by the spring 140 toward the first position.

In addition, in accordance with another aspect of the present disclosure, the aerosol-generating device 100 may further include an input interface 22, configured to receive inputs, and a controller 20, configured to perform control such that power is applied to the magnetic-force-generating unit 160 or 160′ (S12) based on an input to close the cover 123 received via the input interface 22 (S11).

In addition, in accordance with another aspect of the present disclosure, the aerosol-generating device 100 may further include a sensor 21, disposed adjacent to the insertion space 114 to sense whether a stick 200 is disposed in the insertion space 114, and a controller 20, configured to perform control such that power is applied to the magnetic-force-generating unit 160 or 160′ (S23) when the stick 200 is removed from the insertion space 114 (S21).

In addition, in accordance with another aspect of the present disclosure, the power is applied to the magnetic-force-generating unit 160 or 160′ (S23) when a first predetermined time elapses after the stick 200 is removed from the insertion space 114 (Yes in S22).

In addition, in accordance with another aspect of the present disclosure, the aerosol-generating device 100 may further include a heater 30, disposed adjacent to the insertion space 114, and a controller 20, configured to perform control such that power is applied to the magnetic-force-generating unit 160 or 160′ (S33) when the heater 30 is turned off (S31).

In addition, in accordance with another aspect of the present disclosure, the power is applied to the magnetic-force-generating unit 160 or 160′ (S33) when a second predetermined time elapses after the heater 30 is turned off (S32).

In addition, in accordance with another aspect of the present disclosure, the cover 123 may be moveable between a first position at which the insertion space 114 is closed and a second position at which the insertion space 114 is open. The magnetic-force-generating unit 160 or 160′ may be disposed adjacent to the first position and may be operable to apply the repulsive magnetic force to the cover 123 toward the second position when power is applied to the magnetic-force-generating unit 160 to 160′.

In addition, in accordance with another aspect of the present disclosure, the aerosol-generating device may further comprise a first magnet 150 disposed adjacent to the first position to apply a second attractive force to the cover 123 to secure the cover 123 at the first position. the spring 140 may be configured to apply the elastic force to the cover 123 toward the second position.

In addition, in accordance with another aspect of the present disclosure, the cover 123 may be secured at the first position by the second attractive magnetic force applied by the first magnet 150 to the cover 123 despite the elastic force applied to the cover 123 by the spring 140 toward the second position.

In addition, in accordance with another aspect of the present disclosure, the repulsive magnetic force applied by the magnetic-force-generating unit 160 or 160′ may overcome the second attractive magnetic force of the first magnet 150 securing the cover 123 at the first position to move the cover 123 toward the second position.

In addition, in accordance with another aspect of the present disclosure, the spring 140 may be configured to apply the elastic force to the cover 123 toward the second position. The magnetic-force-generating unit 160′ may include a solenoid 161, and a second magnet 165, disposed inside the solenoid 161 to apply a third attractive magnetic force to the cover 123.

In addition, in accordance with another aspect of the present disclosure, the third attractive magnetic force may secure the cover 123 when power is not applied to the solenoid 161, and the repulsive magnetic force to the cover 123 by the magnetic-force-generating unit 160′ when power is applied to the solenoid 161.

In addition, in accordance with another aspect of the present disclosure, the repulsive magnetic force applied by the magnetic-force-generating unit 160′ may overcome the third attractive magnetic force the second magnet 165 to to move the cover toward the second position.

In addition, in accordance with another aspect of the present disclosure, the aerosol-generating device 100 may further include an input interface 22, configured to receive inputs, and a controller 20, configured to perform control such that power is applied to the magnetic-force-generating unit 160 or 160′ (S42) based on an input to close the cover received via the input interface 22 (S41).

In addition, in accordance with another aspect of the present disclosure, the aerosol-generating device 100 may further include a heater 30, disposed adjacent to the insertion space 114, and a controller 20, configured to perform control such that power is applied to the magnetic-force-generating unit 160 or 160′ (S52) when the heater 30 is turned on (S51).

In addition, in accordance with another aspect of the present disclosure, the magnetic-force-generating unit 160 or 160′ may include a solenoid 161 wound along the direction parallel to a movement direction of the cover.

In addition, in accordance with another aspect of the present disclosure, the magnetic-force-generating unit 160 or 160′ may further include an electromagnet 163 disposed inside the solenoid 161 and extending in parallel to the movement direction.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a housing having therein an elongated insertion space;
a cap configured to cover at least a portion of the housing at which the insertion space is formed, the cap comprising an opening corresponding to the insertion space;
a cover coupled to the cap and movable to open or close the insertion space;
a spring having a first side supported by the cap and a second side supported by the cover and configured to apply an elastic force to the cover; and
a magnetic-force-generating unit mounted to the cap and operable to apply an attractive magnetic force or a repulsive magnetic force to the cover.

2. The aerosol-generating device according to claim 1, wherein the cover is moveable between a first position at which the insertion space is closed and a second position at which the insertion space is open, and
wherein the magnetic-force-generating unit is disposed adjacent to the second position and operable to apply the repulsive magnetic force to the cover toward the first position when power is applied to the magnetic-force-generating unit.

3. The aerosol-generating device according to claim 2, further comprising a first magnet disposed adjacent to the second position to apply a second attractive magnetic force to the cover to secure the cover at the second position,
wherein the spring is configured to apply the elastic force to the cover toward the first position.

4. The aerosol-generating device according to claim 3, wherein the cover is secured at the second position by the second attractive magnetic force applied by the first magnet despite the elastic force applied to the cover by the spring toward the first position.

5. The aerosol-generating device according to claim 3, wherein the repulsive magnetic force applied by the magnetic-force-generating unit overcomes the second attractive magnetic force of the first magnet securing the cover at the second position to move the cover toward the first position.

6. The aerosol-generating device according to claim 2, wherein the spring is configured to apply the elastic force to the cover toward the first position, and
wherein the magnetic-force-generating unit comprises:
a solenoid; and
a second magnet disposed inside the solenoid to apply a third attractive magnetic force to the cover.

7. The aerosol-generating device according to claim 6, wherein the third attractive magnetic force secures the cover at the second position when power is not applied to the magnetic-force-generating unit, and the repulsive magnetic force is applied to the cover by the magnetic-force-generating unit to overcome the third attractive magnetic force and move the cover toward the first position when power is applied to the magnetic-force-generating unit.

8. The aerosol-generating device according to claim 6, wherein the cover is secured at the second position by the third attractive magnetic force applied by the second magnet despite the elastic force applied to the cover by the spring toward the first position.

9. The aerosol-generating device according to claim 2, further comprising:
an input interface configured to receive inputs; and
a controller configured to perform control such that power is applied to the magnetic-force-generating unit based on an input to close the cover received via the input interface.

10. The aerosol-generating device according to claim 2, further comprising:
a sensor disposed adjacent to the insertion space to sense whether a stick is disposed in the insertion space; and
a controller configured to perform control such that power is applied to the magnetic-force-generating unit when the stick is removed from the insertion space.

11. The aerosol-generating device according to claim 10, wherein the power is applied to the magnetic-force-generating unit when a first predetermined time elapses after the stick is removed from the insertion space.

12. The aerosol-generating device according to claim 2, further comprising:
a heater disposed adjacent to the insertion space; and
a controller configured to perform control such that power is applied to the magnetic-force-generating unit when the heater is turned off.

13. The aerosol-generating device according to claim 12, wherein the power is applied to the magnetic-force-generating unit when a second predetermined time elapses after the heater is turned off.

14. The aerosol-generating device according to claim 1, wherein the cover is moveable between a first position at which the insertion space is closed and a second position at which the insertion space is open, and
wherein the magnetic-force-generating unit is disposed adjacent to the first position and operable to apply the repulsive magnetic force to the cover toward the second position when power is applied to the magnetic-force-generating unit.

15. The aerosol-generating device according to claim 14, further comprising a first magnet disposed adjacent to the first position to apply a second attractive force to the cover to secure the cover at the first position,
wherein the spring is configured to apply the elastic force to the cover toward the second position.

16. The aerosol-generating device according to claim 15, wherein the cover is secured at the first position by the second attractive magnetic force applied by the first magnet despite the elastic force applied to the cover by the spring toward the second position.

17. The aerosol-generating device according to claim 15, wherein the repulsive magnetic force applied by the magnetic-force-generating unit overcomes the second attractive magnetic force of the first magnet securing the cover at the first position to move the cover toward the second position.

18. The aerosol-generating device according to claim 14, wherein the spring is configured to apply the elastic force to the cover toward the second position, and
wherein the magnetic-force-generating unit comprises:
a solenoid; and
a second magnet disposed inside the solenoid to apply a third attractive magnetic force to the cover.

19. The aerosol-generating device according to claim 18, wherein the third attractive magnetic force secures the cover at the first position when power is not applied to the magnetic-force-generating unit, and the repulsive magnetic force is applied to the cover by the magnetic-force-generating unit to overcome the third attractive magnetic force and move the cover toward the second position when power is applied to the magnetic-force-generating unit.

20. The aerosol-generating device according to claim 19, wherein the repulsive magnetic force applied by the magnetic-force-generating unit overcomes the third attractive magnetic force of the second magnet to move the cover toward the second position.

21. The aerosol-generating device according to claim 14, further comprising:
an input interface configured to receive inputs; and
a controller configured to perform control such that power is applied to the magnetic-force-generating unit based on an input to open the cover received via the input interface.

22. The aerosol-generating device according to claim 14, further comprising:
a heater disposed adjacent to the insertion space; and
a controller configured to perform control such that power is applied to the magnetic-force-generating unit when the heater is turned on.

23. The aerosol-generating device according to claim 1, wherein the magnetic-force-generating unit comprises a solenoid wound along a direction parallel to a movement direction of the cover.

24. The aerosol-generating device according to claim 23, wherein the magnetic-force-generating unit further comprises an electromagnet disposed inside the solenoid and extending parallel to the movement direction.
